(19) United States
(12) Patent Application Publication
(10) Pub. No.: US 2020/0072348 A1
(43) Pub. Date: Mar. 5, 2020

(54) ELECTRIC ACTUATOR

(71) Applicant: NIDEC TOSOK CORPORATION, Kanagawa (JP)

(72) Inventor: Yuzo AKASAKA, Kanagawa (JP)

(73) Assignee: NIDEC TOSOK CORPORATION, Kanagawa (JP)

(21) Appl. No.: 16/559,618

(22) Filed: Sep. 3, 2019

(30) Foreign Application Priority Data
Sep. 5, 2018 (JP) 2018-166298

(51) Int. Cl. F16H 61/32; H02K 7/08; H02K 7/116; H02K 11/215; H02K 11/33; H02K 21/14; F16H 1/28

(52) U.S. Cl. CPC F16H 61/32; H02K 7/083; H02K 7/116; F16H 57/0486; H02K 11/33; H02K 21/14; F16H 1/28; H02K 11/215

(57) ABSTRACT

An electric actuator includes: a motor unit having a motor shaft extending in an axial direction; a deceleration mechanism that is coupled to the motor shaft; an output unit having an output shaft to which rotation of the motor shaft is transmitted via the deceleration mechanism; and a control unit that drives the motor unit based on an output-shaft rotating command which is input from a host device. The control unit includes a motor rotational-angle determination unit that determines a rotational angle of the motor shaft based on the output-shaft rotating command, the rotational angle being necessary for rotating the output shaft from a rotation starting position to a rotation ending position, and a motor driving unit that rotates the motor shaft by the rotational angle determined by the motor rotational-angle determination unit.

### CROSS-REFERENCE TO RELATED APPLICATION

This application claims the priority of Japan patent application serial no. 2018-166298, filed on Sep. 5, 2018. The entirety of the above-mentioned patent application is hereby incorporated by reference herein and made a part of this specification.

### BACKGROUND

### Technical Field

The disclosure relates to an electric actuator.

### Related Art

Conventionally, a shift-by-wire type transmission control device is known in which an electric actuator performs range switching of an automatic transmission.

[Patent literature 1] International Publication No. 2014/115300

In conventional transmission control, while a motor of an electric actuator is rotated, an angular position of a manual shaft is detected at a side of an automatic transmission, and feedback control is performed in which the motor is rotated so that a current position of the manual shaft is coincident with a target position thereof. However, in a case of driving the electric actuator by the feedback control, it is necessary to perform arithmetic processing for control, position initialization processing of the manual shaft, or the like. Therefore, it is difficult to increase a speed of range switching.

### SUMMARY

According to a first aspect of the disclosure, an electric actuator is provided which includes: a motor unit having a motor shaft extended in an axial direction; a deceleration mechanism that is coupled to one side or the other side of the motor shaft in the axial direction; an output unit having an output shaft to which rotation of the motor shaft is transmitted via the deceleration mechanism; and a control unit that drives the motor unit based on an output-shaft rotating command which is input from a host device. The control unit includes a motor rotational-angle determination unit that determines, based on the output-shaft rotating command, a rotational angle of the motor shaft necessary for rotating the output shaft from a rotation starting position to a rotation ending position, and a motor driving unit that rotates the motor shaft by the rotational angle determined by the motor rotational-angle determination unit.

### BRIEF DESCRIPTION OF THE DRAWINGS

FIG. 1 is a cross-sectional view of an electric actuator of an embodiment.

FIG. 2 is a perspective view illustrating a deceleration mechanism.

FIG. 3 is a partial plan view illustrating a gear portion of an external gear.

FIG. 4 is a partial plan view illustrating a gear portion of an internal gear.

FIG. 5 is an enlarged partial plan view of a part in which the external gear intermeshes with the internal gear.

FIG. 6 is a functional block diagram of the electric actuator of the embodiment.

### DESCRIPTION OF THE EMBODIMENTS

An aspect of the disclosure provides an electric actuator configured to be capable of switching an angular position of an output shaft at a high speed.

According to an aspect of the disclosure, an electric actuator configured to be capable of switching an angular position of an output shaft at a high speed is provided.

Hereinafter, an embodiment of the disclosure is described with reference to the drawings.

In the drawings, a Z-axis direction is an up-down direction in which a positive side is an upper side, and a negative side is a lower side. An axial direction of a central axis J1 which is a virtual axis appropriately illustrated in the drawings is parallel to the Z-axis direction, that is, the up-down direction. An X-axis direction is a direction orthogonal to the Z-axis direction. In a case of the embodiment, when viewed in the Z-axis direction, a direction in which the central axis J1 of a motor shaft 41 and an output central axis J3 of an output shaft 61 is connected is set as the X-axis direction. A Y-axis direction is a direction orthogonal to both the Z-axis direction and the X-axis direction. In the following description, a direction parallel to the axial direction of the central axis J1 is simply referred to as an “axial direction Z”. In addition, unless otherwise described, a radial direction with the central axis J1 as a centre is simply referred to as a “radial direction”, and a circumferential direction with the central axis J1 as a centre is simply referred to as a “circumferential direction”.

In the embodiment, the upper side corresponds to one side in the axial direction. Besides, the upper side and the lower side are merely terms for describing a relative positional relationship between each section, and an actual dispositional relationship or the like may be a dispositional relationship or the like other than a dispositional relationship or the like described by the terms.

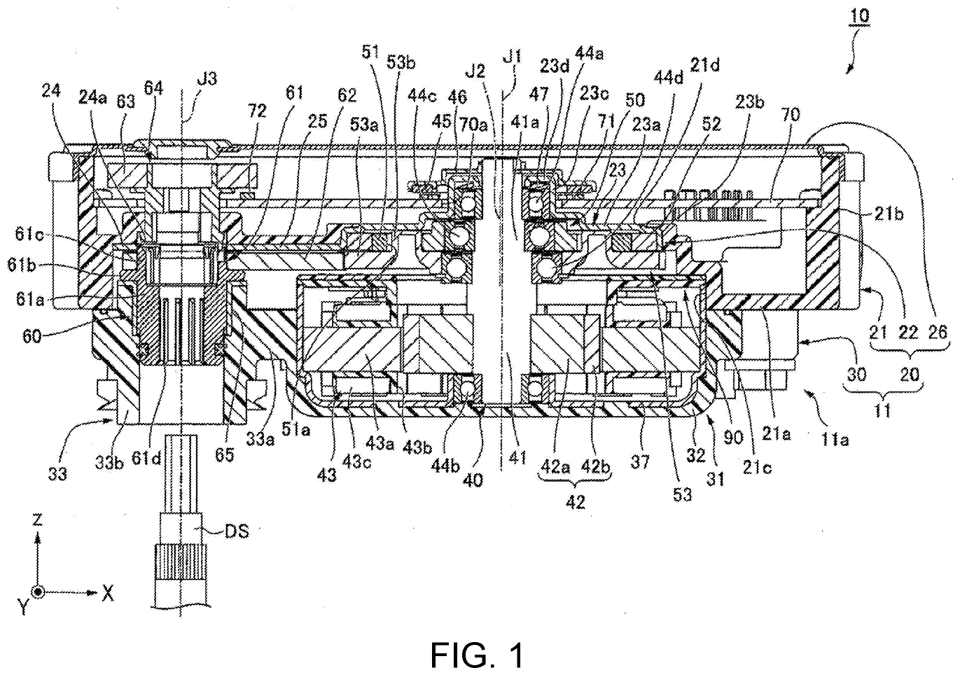

FIG. 1 is a cross-sectional view of an electric actuator of the embodiment. An electric actuator 10 is attached to a vehicle. The electric actuator 10 is mounted on a shift-by-wire type actuator device that is driven based on a shift operation by a driver of a vehicle. The electric actuator 10 includes a motor unit 40, a deceleration mechanism 50, an output unit 60, a circuit board 70, a motor-unit sensor 71, an output-unit sensor 72, a housing 11, a bus-bar holder 90, and a bus bar not illustrated.

The motor unit 40 includes the motor shaft 41, a first bearing 44a, a second bearing 44b, a third bearing 44c, a fourth bearing 44d, a rotor body 42, a stator 43, a sensor magnet for motor unit 45, and a magnet holder 46. The motor shaft 41 extends in the axial direction Z.

The first bearing 44a, the second bearing 44b, the third bearing 44c, and the fourth bearing 44d support the motor shaft 41 in a rotatable manner around the central axis J1. In the embodiment, the first bearing 44a, the second bearing 44b, the third bearing 44c, and the fourth bearing 44d are ball bearings, for example.

An eccentric shaft portion 41a, which is a portion of the motor shaft 41 supported by the third bearing 44c, has a columnar shape that is parallel to the central axis J1 and extends with an eccentric axis J2 as a centre, the eccentric axis J2 being eccentric with respect to the central axis J1. The portion of the motor shaft 41 other than the eccentric shaft portion 41a has a columnar shape that extends with the central axis J1 as a centre.

The rotor body 42 is fixed to the motor shaft 41. More specifically, the rotor body 42 is fixed to a portion of the motor shaft 41 at the lower side. The rotor body 42 has a rotor core 42a and a rotor magnet 42b. The rotor core 42a is fixed to an outer circumferential surface of a portion of the motor shaft 41, the portion being positioned lower than the eccentric shaft portion 41a. The rotor magnet 42b is fixed to an outer circumferential surface of the rotor core 42a.

The stator 43 is disposed at an outer side of the rotor body 42 in the radial direction with a gap therebetween. The stator 43 has a ring shape that surrounds the outer side of the rotor body 42 in the radial direction. The stator 43 has a stator core 43a, an insulator 43b, and a plurality of coils 43c. The coils 43c are mounted on the stator core 43a via the insulator 43b.

The magnet holder 46 has an annular shape centred on the central axis J1. The magnet holder 46 is fixed to an outer circumferential surface at an end portion of the motor shaft 41 at the upper side. The sensor magnet for motor unit 45 has an annular plate shape centred on the central axis J1. A plate surface of the sensor magnet for motor unit 45 is orthogonal to the axial direction Z. The sensor magnet for motor unit 45 is fixed to an outer circumferential edge portion of an under surface of the magnet holder 46 in the radial direction. Consequently, the sensor magnet for motor unit 45 is attached to the motor shaft 41 via the magnet holder 46. In the embodiment, the sensor magnet for motor unit 45 is attached to a portion of the motor shaft 41 projecting further toward the upper side than the circuit board 70, and faces a surface of the circuit board 70 at the upper side with a gap therebetween.

The deceleration mechanism 50 is coupled to the upper side of the motor shaft 41. The deceleration mechanism 50 is disposed at the upper side of the rotor body 42 and the stator 43. The deceleration mechanism 50 includes an external gear 51, an internal gear 52, and an output gear 53.

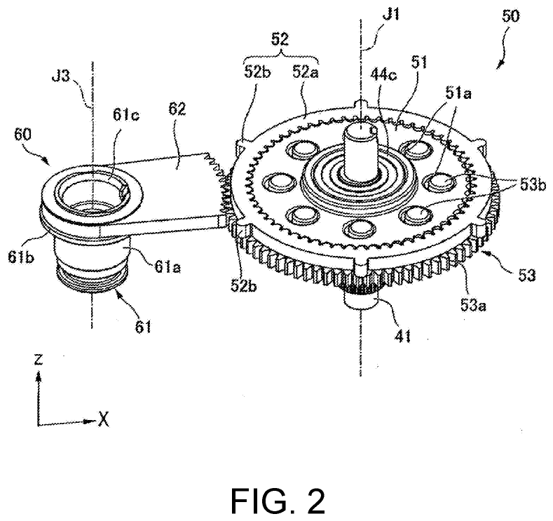

FIG. 2 is a perspective view illustrating the deceleration mechanism 50. As illustrated in FIGS. 1 and 2, the external gear 51 has an annular plate shape expanding in a radial direction of the eccentric axis J2, with the eccentric axis J2 of the eccentric shaft portion 41a as a centre. A gear portion is arranged at an outer surface of the external gear 51 in the radial direction. The external gear 51 is connected to the motor shaft 41 via the third bearing 44c. Consequently, the deceleration mechanism 50 is coupled to the motor shaft 41. The external gear 51 is fitted into an outer ring of the third bearing 44c from an outer side in the radial direction. Consequently, the third bearing 44c couples the motor shaft 41 and the external gear 51 to each other in a manner of being relatively rotatable around the eccentric axis J2.

The external gear 51 has a plurality of holes 51a that penetrates the external gear 51 in the axial direction Z. The plurality of holes 51a is disposed at equal intervals over an entire circumference along the circumferential direction around the eccentric axis J2. As illustrated in FIG. 2, the hole 51a has a circular shape when viewed along the axial direction Z.

Surrounding the outer side of the external gear 51 in the radial direction, the internal gear 52 is fixed to a circuit-board case 20 and intermeshes with the external gear 51. The internal gear 52 is held by a metal member 22, which is described later, of the housing 11. The internal gear 52 has an internal-gear body 52a and a plurality of protruding portions 52b. The internal-gear body 52a has an annular shape centred on the central axis J1. A gear portion is arranged on an inner circumferential surface of the internal-gear body 52a. The gear portion of the internal-gear body 52a intermeshes with the gear portion of the external gear 51. The protruding portion 52b projects toward an outer side in the radial direction from an outer circumferential surface of the internal-gear body 52a. The plurality of protruding portions 52b is disposed at equal intervals over an entire circumference along the circumferential direction.

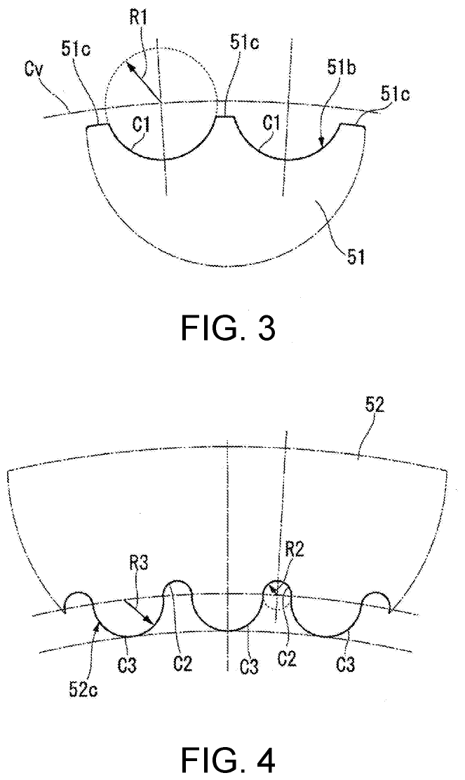

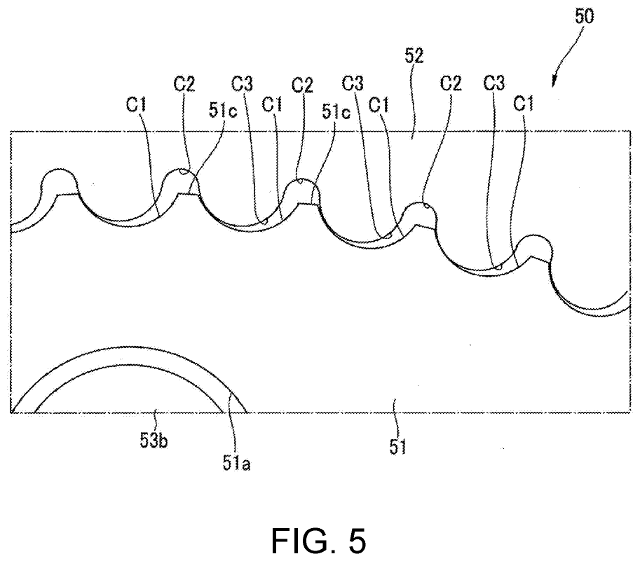

FIG.3 is a partial plan view illustrating the gear portion of the external gear. FIG.4 is a partial plan view illustrating the gear portion of the internal gear. FIG. 5 is an enlarged partial plan view of a portion in which the external gear intermeshes with the internal gear.

As illustrated in FIG. 3, the external gear 51 has, when viewed in the axial direction, a first gear portion 51b having a shape in which flat portions 51c that configure addenda and first arcs C1 that configure dedenda are alternately continuous. As illustrated in FIG. 4, the internal gear 52 has, when viewed in the axial direction, a second gear portion 52c having a shape in which second arcs C2 that configure dedenda and third arcs C3 that configure addenda are alternately continuous.

In the portion illustrated in FIG. 5 in which the external gear 51 intermeshes with the internal gear 52, the first arcs C1 of the dedenda of the external gear 51 and the third arcs C3 that configure the addenda of the internal gear 52 move while coming into contact with each other. The external gear 51 intermeshes with the internal gear 52 in inscribed contact with simple circles having different diameters from each other, and thereby surface pressure of a gear surface can be reduced. Consequently, good lubricity is obtained, and heat generation also decreases, and thus a highly efficient deceleration mechanism is achieved.

As illustrated in FIG. 3, in the external gear 51, the flat portion 51c of the first gear portion 51b is positioned at an inner side in the radial direction from a virtual circle Cv obtained by connecting centres of a plurality of first arcs C1 in the circumferential direction. By arranging the flat portion 51c on the external gear 51, contact between teeth when a tooth of the external gear 51 moves out from a tooth groove of the internal gear 52 can be avoided. Consequently, a difference between a radius R1 of the first arc Cl in the external gear 51 and a radius R3 of the third arc C3 in the internal gear 52 can be decreased. As a result, a backlash can be reduced, and positional accuracy of the electric actuator 10 is improved.

In addition, in the embodiment, since a basic shape of a tooth shape of the external gear 51 and the internal gear 52 can be configured of three arcs, it is easy to manufacture and easy to improve accuracy.

In the external gear 51 of the embodiment, a chamfered portion having a size of, for example, R 0.05 mm to 0.2 mm may be arranged at a corner portion at which the first arc C1 is connected to the flat portion 51c. Consequently, friction when the external gear 51 intermeshes with the internal gear 52 can be reduced, and transmission efficiency of the deceleration mechanism 50 can be improved. On the other hand, as a chamfered width of the corner portion increases, the backlash of the deceleration mechanism 50 increases. Hence, according to an embodiment, the chamfered portion has a size of R 0.15 mm or smaller.

In the embodiment, at least one tooth surface of the external gear 51 and the internal gear 52 may be configured to have a recessed portion that holds a lubricant. The recessed portion of the tooth surface can be arranged by shot blasting or coining, for example. According to this configuration, it is possible to hold an appropriate amount of lubricant in a portion in which the external gear 51 intermeshes with the internal gear 52. Consequently, for example, even when viscosity of the lubricant increases at a low temperature and the lubricant is unlikely to flow, it is possible to inhibit the deceleration mechanism 50 from becoming hard to move. In addition, friction of the gears decreases, and thereby improvement in efficiency and service life extension of the deceleration mechanism 50 and the electric actuator 10 are achieved.

The output gear 53 has an output-gear body 53a and a plurality of pins 53b. The output-gear body 53a is disposed at the lower side of the external gear 51 and the internal gear 52. The output-gear body 53a has an annular plate shape expanding in the radial direction around the central axis J1. A gear portion is arranged at an outer surface of the output-gear body 53a in the radial direction. The gear portion of the output-gear body 53a projects further toward the outer side in the radial direction than the internal-gear body 52a. As illustrated in FIG. 1, the output-gear body 53a is connected to the motor shaft 41 via the fourth bearing 44d.

The plurality of pins 53b has a cylindrical shape projecting upward from a top surface of the output-gear body 53a. As illustrated in FIG. 2, the plurality of pins 53b is disposed at equal intervals over an entire circumference along the circumferential direction. An outer diameter of the pin 53b is smaller than an inner diameter of the hole 51a. The plurality of pins 53b passes through the plurality of holes 51a from the lower side, respectively. An outer circumferential surface of the pin 53b is inscribed in an inner circumferential surface of the hole 51a. The inner circumferential surfaces of the holes 51a support the external gear 51 via the pins 53b so that the external gear 51 is capable of oscillating around the central axis J1.

The output unit 60 is a portion that outputs a drive force of the electric actuator 10. As illustrated in FIG. 1, the output unit 60 is disposed at the outer side from the motor unit 40 in the radial direction. The output unit 60 includes the output shaft 61, a drive gear 62, a sensor magnet for output unit 63, and a magnet holder 64.

As illustrated in FIG. 2, the output shaft 61 has a tubular shape extending in the axial direction Z of the motor shaft 41. In this manner, the output shaft 61 extends in the same direction as the motor shaft 41, and thus it is possible to simplify a structure of the deceleration mechanism 50 that transmits the rotation of the motor shaft 41 to the output shaft 61. In the embodiment, the output shaft 61 has a cylindrical shape. The output shaft 61 is centred on the output central axis J3 which is a virtual axis. The output central axis J3 is parallel to the central axis J1 and is disposed to be separated from the central axis J1 in the radial direction. In other words, the motor shaft 41 and the output shaft 61 are disposed to be separated from each other in the radial direction of the motor shaft 41. According to this configuration, the motor unit 40 and the output unit 60 are aligned in the radial direction of the motor shaft 41, and thus the electric actuator 10 can be thinned in the axial direction.

As illustrated in FIG. 1, the output shaft 61 has an opening portion 61d that is open at the lower side. In the embodiment, the output shaft 61 is opened at both sides in the axial direction. A lower portion of an inner circumferential surface of the output shaft 61 has a spline groove. The output shaft 61 has an output-shaft body 61a having a cylindrical shape and a flange portion 61b projecting outward from the output-shaft body 61a in the radial direction of the output central axis J3. The output shaft 61 is disposed at a position overlapping with the rotor body 42 in the radial direction of the motor shaft 41. An end portion at the lower side of the output shaft 61, that is, the opening portion 61d is disposed at the upper side from an end portion of the motor unit 40 at the lower side. In the embodiment, the end portion of the motor unit 40 at the lower side is an end portion of the motor shaft 41 at the lower side.

A driven shaft DS is inserted to be coupled to the output shaft 61 via the opening portion 61d from the lower side. More specifically, a spline portion arranged at an outer circumferential surface of the driven shaft DS is fitted into the spline groove arranged in the inner circumferential surface of the output shaft 61, and thereby the output shaft 61 and the driven shaft DS are coupled to each other. A drive force of the electric actuator 10 is transmitted to the driven shaft DS via the output shaft 61. Consequently, the electric actuator 10 rotates the driven shaft DS around the output central axis J3.

The drive gear 62 is fixed to the output shaft 61 and intermeshes with the output gear 53. In the embodiment, the drive gear 62 is fixed to a portion of an outer circumferential surface of the output-shaft body 61a, the portion being positioned at the upper side from the flange portion 61b. The drive gear 62 is in contact with a top surface of the flange portion 61b. As illustrated in FIG. 2, the drive gear 62 is a sector gear that extends from the output shaft 61 toward the output gear 53 and has a width that increases as the drive gear 62 approaches the output gear 53. A gear portion is arranged at an end portion of the drive gear 62 at a side of the output gear 53. The gear portion of the drive gear 62 intermeshes with the gear portion of the output gear 53.

As illustrated in FIG. 1, the magnet holder 64 is a member having a substantially cylindrical shape which extends in the axial direction Z with the output central axis J3 as a centre. The magnet holder 64 is open at both sides in the axial direction. The magnet holder 64 is disposed at the upper side of the output shaft 61 and at the outer side of the deceleration mechanism 50 in the radial direction. The magnet holder 64 penetrates the circuit board 70 in the axial direction Z. The interior of the magnet holder 64 is connected to the interior of the output shaft 61. An upper end portion of the driven shaft DS inserted into the output shaft 61 is press-fitted into the magnet holder 64. Consequently, the magnet holder 64 is fixed to the driven shaft DS.

The sensor magnet for output unit 63 has an annular shape centred on the output central axis J3. The sensor magnet for output unit 63 is fixed to an outer circumferential surface of an end portion of the magnet holder 64 at the upper side. By fixing the magnet holder 64 to the driven shaft DS, the sensor magnet for output unit 63 is fixed to the driven shaft DS via the magnet holder 64. The sensor magnet for output unit 63 faces the surface of the circuit board 70 at the upper side with a gap therebetween.

When the motor shaft 41 rotates around the central axis J1, the eccentric shaft portion 41a revolves around the central axis J1 in the circumferential direction. The revolution of the eccentric shaft portion 41a is transmitted to the external gear 51 via the third bearing 44c, and the external gear 51 oscillates while a position at which the inner circumferential surface of the hole 51a is inscribed with the outer circumferential surface of the pin 53b is changed. Consequently, a position at which the gear portion of the external gear 51 intermeshes with the gear portion of the internal gear 52 is changed in the circumferential direction. Hence, a rotating force of the motor shaft 41 is transmitted to the internal gear 52 via the external gear 51.

Here, in the embodiment, the internal gear 52 is fixed and thus is not rotated. Therefore, the external gear 51 is rotated around the eccentric axis J2 due to a reaction force of the rotating force transmitted to the internal gear 52. In this case, a rotating orientation of the external gear 51 is opposite to the rotating orientation of the motor shaft 41. The rotation of the external gear 51 around the eccentric axis J2 is transmitted to the output gear 53 via the holes 51a and the pins 53b. Consequently, the output gear 53 is rotated around the central axis J1. The rotation of the motor shaft 41 is decelerated and transmitted to the output gear 53.

When the output gear 53 is rotated, the drive gear 62 intermeshing with the output gear 53 is rotated around the output central axis J3. Consequently, the output shaft 61 fixed to the drive gear 62 is rotated around the output central axis J3. In this manner, the rotation of the motor shaft 41 is transmitted to the output shaft 61 via the deceleration mechanism 50.

The circuit board 70 is disposed at the upper side from the rotor body 42. The circuit board 70 is disposed at the upper side of the deceleration mechanism 50. The circuit board 70 has a plate shape in which a plate surface thereof is orthogonal to the axial direction Z. The circuit board 70 has a through-hole 70a that penetrates the circuit board 70 in the axial direction Z. The motor shaft 41 passes through the through-hole 70a. Consequently, the motor shaft 41 penetrates the circuit board 70 in the axial direction Z. The circuit board 70 is electrically connected to the stator 43 via a bus bar not illustrated. In other words, the circuit board 70 is electrically connected to the motor unit 40.

The motor-unit sensor 71 is fixed to a top surface of the circuit board 70. More specifically, the motor-unit sensor 71 is fixed to a portion of the surface of the circuit board 70 at the upper side, the portion facing the sensor magnet for motor unit 45 with a gap therebetween in the axial direction Z. The motor-unit sensor 71 is a magnetic sensor that detects a magnetic field of the sensor magnet for motor unit 45. The motor-unit sensor 71 is a Hall element, for example. Three motor-unit sensors 71 are arranged along the circumferential direction, although not illustrated. The motor-unit sensor 71 detects the magnetic field of the sensor magnet for motor unit 45, thereby, detecting a rotational position of the sensor magnet for motor unit 45 to detect rotation of the motor shaft 41.

In the embodiment, the deceleration mechanism 50 is coupled to the upper side of the motor shaft 41, and the circuit board 70 is disposed at the upper side from the rotor body 42 and at the upper side of the deceleration mechanism 50. Therefore, the deceleration mechanism 50 is disposed between the circuit board 70 and the rotor body 42 in the axial direction Z. Consequently, the motor-unit sensor 71 fixed to the circuit board 70 can be disposed to be separated from the rotor body 42 and the stator 43. Hence, the motor-unit sensor 71 is unlikely to be influenced by a magnetic field produced from the rotor body 42 and the stator 43, and detection accuracy of the motor-unit sensor 71 can be improved.

The output-unit sensor 72 is fixed to the top surface of the circuit board 70. More specifically, the output-unit sensor 72 is fixed to a portion of the surface of the circuit board 70 at the upper side, the portion facing the sensor magnet for output unit 63 with a gap therebetween in the axial direction Z. The output-unit sensor 72 is a magnetic sensor that detects a magnetic field of the sensor magnet for output unit 63. The output-unit sensor 72 is a Hall element, for example. Three output-unit sensors 72 are arranged along the circumferential direction around the output central axis J3, although not illustrated. The output-unit sensor 72 detects the magnetic field of the sensor magnet for output unit 63, thereby, detecting a rotational position of the sensor magnet for output unit 63 to detect rotation of the driven shaft DS.

The electric actuator 10 of the embodiment includes the output-unit sensor 72 that detects an angular position of the driven shaft DS coupled to the output shaft 61. Specifically, the output-unit sensor 72 detects the magnetic field of the sensor magnet for output unit 63 which is mounted on the driven shaft DS. According to this configuration, the output-unit sensor 72 is capable of detecting the angular position of the driven shaft DS with high accuracy without being influenced by the backlash at a coupled portion between the output shaft 61 and the driven shaft DS. Hence, the electric actuator 10 is capable of controlling the angular position of the driven shaft DS with high accuracy based on the output from the output-unit sensor 72.

The housing 11 accommodates the motor unit 40, the deceleration mechanism 50, the output unit 60, the circuit board 70, the motor-unit sensor 71, the output-unit sensor 72, the bus-bar holder 90, and the bus bar not illustrated. The housing 11 has a motor case 30 and the circuit-board case 20. The motor case 30 is open at the upper side. As illustrated in FIG. 1, the motor case 30 has a motor-case body 31 and a stator fixing member 37. In other words, the housing 11 has the motor-case body 31 and the stator fixing member 37.

The circuit-board case 20 has a substantially rectangular-parallelepiped box shape. The circuit-board case 20 is attached to an upper side of the motor case 30. The circuit-board case 20 blocks the opening of the motor case 30. The circuit-board case 20 accommodates the circuit board 70. The circuit-board case 20 has a circuit-board case body 21, a metal member 22, and a circuit-board case cover 26. In other words, the housing 11 has the circuit-board case body 21, the metal member 22, and the circuit-board case cover 26.

As illustrated in FIG. 1, the circuit-board case body 21 has a box shape which is open at the upper side. The circuit-board case body 21 is larger than the motor-case body 31 and overlaps the entire motor-case body 31, when viewed in the axial direction Z. The circuit-board case body 21 has a bottom wall 21a and a side wall 21b. In other words, the circuit-board case 20 has the bottom wall 21a and the side wall 21b. The bottom wall 21a expands along a plane orthogonal to the axial direction Z. The bottom wall 21a expands further outward in the radial direction than the motor-case body 31, when viewed in the axial direction Z. The bottom wall 21a blocks the opening of the motor case 30 at the upper side. The bottom wall 21a covers an upper side of the stator 43.

The bottom wall 21a has a recessed portion 21c recessed from a surface of the bottom wall 21a at the lower side toward the upper side. The bottom wall 21a has a central through-hole 21d that penetrates the bottom wall 21a in the axial direction Z. The central through-hole 21d penetrates the bottom wall 21a from a bottom surface of the recessed portion 21c to a surface of the bottom wall 21a at the upper side. The central through-hole 21d has a circular shape centred on the central axis J1, when viewed in the axial direction Z. The motor shaft 41 passes through the central through-hole 21d.

The side wall 21b has a square-tubular shape projecting upward from an outer edge portion of the bottom wall 21a. The circuit board 70 is accommodated at an inner side of the side wall 21b. In other words, the circuit-board case 20 accommodates the circuit board 70 at the upper side from the bottom wall 21a. The side wall 21b is open at an upper side thereof. The opening of the side wall 21b at the upper side, that is, the opening of the circuit-board case 20 at the upper side, is blocked by the circuit-board case cover 26. The circuit-board case cover 26 is made of metal, for example.

The metal member 22 is made of metal. As illustrated in FIG. 1, the metal member 22 is held by the circuit-board case body 21. In other words, the metal member 22 is held by a housing body 11a. The metal member 22 is accommodated and held within the recessed portion 21c. In the embodiment, a part of the metal member 22 is embedded in the housing body 11a. Therefore, it is possible to produce a part or the entirety of the housing body 11a using insert molding in which the metal member 22 is inserted into a mold and a resin is poured therein. Hence, the housing 11 is easy to manufacture. In the embodiment, the circuit-board case body 21 of the housing body 11a is produced by the insert molding in which the metal member 22 is inserted into a mold and a resin is poured therein.

The metal member 22 has a bearing holder 23, an arm 25, and an output-shaft support 24. The bearing holder 23 has an annular plate portion 23a, an outer tubular portion 23b, an inner tubular portion 23c, and a top plate portion 23d. The annular plate portion 23a has an annular plate shape centred on the central axis J1. A plate surface of the annular plate portion 23a is orthogonal to the axial direction Z.

The outer tubular portion 23b has a cylindrical shape projecting downward from an outer circumferential edge portion of the annular plate portion 23a. The internal gear 52 is fixed to an inner side of the outer tubular portion 23b in the radial direction. Consequently, the deceleration mechanism 50 is held by the surface of the bottom wall 21a at the lower side via the metal member 22. The outer tubular portion 23b is embedded in an inner side of the central through-hole 21d in the radial direction, thereby being held by the circuit-board case body 21.

The inner tubular portion 23c has a cylindrical shape projecting upward from an inner circumferential edge portion of the annular plate portion 23a. The first bearing 44a is held at the inner side of the inner tubular portion 23c in the radial direction. Consequently, the bearing holder 23 holds the first bearing 44a. The inner tubular portion 23c projects further upward than the bottom wall 21a. The inner tubular portion 23c is disposed at the inner side of the side wall 21b in the radial direction. The inner tubular portion 23c penetrates the circuit board 70 via the through-hole 70a in the axial direction Z and projects further upward than the circuit board 70.

Consequently, at least a part of the first bearing 44a which is held by the inner tubular portion 23c is inserted into the through-hole 70a. Therefore, the motor shaft 41 can be supported by the first bearing 44a at a position close to a portion of the motor shaft 41 to which the sensor magnet for motor unit 45 is attached. Consequently, it is possible to inhibit an axis of the portion of the motor shaft 41 to which the sensor magnet for motor unit 45 is attached from being displaced, and it is possible to inhibit the position of the sensor magnet for motor unit 45 from being displaced. Hence, a decrease in the accuracy of the rotation detection of the motor shaft 41 performed by the motor-unit sensor 71 can be inhibited. In addition, when viewed in the radial direction, the first bearing 44a and the circuit board 70 can be disposed to overlap each other, and thus the size of the electric actuator 10 is easily reduced in the axial direction Z.

In this specification, the expression that “the bearing holder holds the first bearing” means that the first bearing may not be fixed to the bearing holder as long as the bearing holder is capable of positioning the first bearing in the radial direction. In the embodiment, the first bearing 44a is positioned in the radial direction by being fitted into the inner tubular portion 23c. The first bearing 44a is not fixed with respect to the inner tubular portion 23c.

The top plate portion 23d projects inward in the radial direction from an end portion of the inner tubular portion 23c at the upper side. The top plate portion 23d has an annular shape centred on the central axis J1 and has a plate shape in which a plate surface thereof is orthogonal to the axial direction Z. The end portion of the motor shaft 41 at the upper side passes through an inner side of the top plate portion 23d. An inner circumferential edge portion of the top plate portion 23d is curved toward the lower side. The top plate portion 23d covers an upper side of the first bearing 44a.

A pre-compression member 47 is disposed between the top plate portion 23d and the first bearing 44a in the axial direction Z. In other words, the electric actuator 10 includes the pre-compression member 47. The pre-compression member 47 is a wave washer having an annular shape extending along the circumferential direction. The pre-compression member 47 comes into contact with a surface of the top plate portion 23d at the lower side and an end portion of an outer ring of the first bearing 44a at the upper side. The pre-compression member 47 applies downward pre-compression to the outer ring of the first bearing 44a.

The arm 25 extends from the bearing holder 23 toward the outer side in the radial direction of the motor shaft 41. The arm 25 has a plate shape in which a plate surface thereof is orthogonal to the axial direction Z. The arm 25 connects the bearing holder 23 and the output-shaft support 24. Consequently, it is easy to minimize the size of a portion of the metal member 22 except the bearing holder 23 and the output-shaft support 24, and it is easy to reduce the size of the metal member 22. Hence, it is easy to reduce manufacturing cost of the housing 11, and it is easy to reduce the weight of the housing 11.

The output-shaft support 24 is connected to an end portion of the arm 25 at the outer side in the radial direction. The output-shaft support 24 has an annular shape centred on the output central axis J3 and has a plate shape in which a plate surface thereof is orthogonal to the axial direction Z. In this manner, according to the embodiment, the output-shaft support 24 and the arm 25 have plate shape, and thus the output-shaft support 24 and the arm 25 can be easily produced by press working of performing punching, bending, or the like on a plate member made of metal. In the embodiment, the metal member 22 is a single member which is produced by performing the press working on a plate member made of metal.

The output-shaft support 24 has a through-hole 24a which penetrates the output-shaft support 24 in the axial direction Z. A fitting portion 61c which is an end portion of the output-shaft body 61a at the upper side is fitted into the through-hole 24a. In other words, the output shaft 61 has the fitting portion 61c which is fitted into the through-hole 24a. Consequently, the output-shaft support 24 supports the output shaft 61.

According to the embodiment, the metal member 22 made of metal can support the first bearing 44a and can support the output shaft 61. Consequently, it is possible to dispose the motor shaft 41, which is supported by the first bearing 44a, and the output shaft 61 at highly accurate relative positions. In addition, the housing body 11a on which the metal member 22 is held is made of resin, and thus the weight of the housing 11 can be reduced. In addition, the metal member 22 is made of metal, and thus the metal member has higher strength and heat resistance than a resin member. Therefore, even when an external force and heat are applied to the housing 11, the metal member 22 can be inhibited from being significantly deformed or damaged, and it is possible to inhibit the motor shaft 41 and the output shaft 61 from shifting.

In addition, according to the embodiment, the fitting portion 61c is fitted into the through-hole 24a, and thereby the output shaft 61 can be easily supported and positioned with respect to the metal member 22. Hence, assembly workability of the electric actuator 10 is improved.

The motor-case body 31 has a motor accommodating portion 32 and an output-unit holder 33. The motor accommodating portion 32 has a bottomed-tubular shape which is open at the upper side. The motor accommodating portion 32 has a cylindrical shape centred on the central axis J1. The motor accommodating portion 32 accommodates the motor unit 40. In other words, the motor-case body 31 accommodates the motor unit 40.

Besides, in this specification, the expression that “the motor-case body accommodates the motor unit” means it is sufficient that a part of the motor unit is accommodated by the motor-case body and the other part of the motor unit may project to the outside of the motor-case body. In the embodiment, the motor-case body 31, that is, the motor accommodating portion 32 accommodates a portion of the motor shaft 41 at the lower side, the rotor body 42, the stator 43, and the second bearing 44b.

The stator fixing member 37 has a bottomed-tubular shape which is open at the upper side. The stator fixing member 37 has a cylindrical shape centred on the central axis J1. The stator fixing member 37 is fitted to the inner side of the motor accommodating portion 32. A plurality of through-holes disposed along the circumferential direction is arranged on a bottom portion of the stator fixing member 37. A plurality of protrusions arranged on a bottom portion of the motor accommodating portion 32 is fitted into the through-holes of the stator fixing member 37, respectively.

An end portion of the stator fixing member 37 at the upper side projects further upward than the motor accommodating portion 32. The second bearing 44b is held at the bottom portion of the stator fixing member 37. An outer circumferential surface of the stator 43 is fixed to an inner circumferential surface of the stator fixing member 37. The stator fixing member 37 is made of metal. The motor case 30 is produced by the insert molding in which a resin is poured in a state that the stator fixing member 37 is inserted into a mold.

The bus-bar holder 90 is disposed at the opening of the stator fixing member 37 at the upper side. The bus-bar holder 90 has an annular shape centred on the central axis J1 and has a plate shape in which a plate surface thereof is orthogonal to the axial direction Z. The bus-bar holder 90 holds a bus bar not illustrated. The bus-bar holder 90 covers the upper side of the stator 43.

The output-unit holder 33 is positioned at the outer side of the motor accommodating portion 32 in the radial direction. The output-unit holder 33 has a base portion 33a and an output-shaft holder 33b. The base portion 33a extends outward from the motor accommodating portion 32 in the radial direction. The output-shaft holder 33b is positioned at a front end portion of the base portion 33a at the outer side in the radial direction, the base portion 33a extending from the motor accommodating portion 32. The output-shaft holder 33b has a cylindrical shape centred on the output central axis J3. The output-shaft holder 33b projects from the base portion 33a toward both sides in the axial direction. The output-shaft holder 33b is open at both sides in the axial direction. The interior of the output-shaft holder 33b penetrates the base portion 33a in the axial direction Z.

A bush 65 having a cylindrical shape is fitted to the inner side of the output-shaft holder 33b. A flange portion projecting toward the outer side in the radial direction around the output central axis J3 is arranged on an end portion of the bush 65 at the upper side. The flange portion of the bush 65 is supported from below by an end portion of the output-shaft holder 33b at the upper side. A portion of the output-shaft body 61a at the lower side from the flange portion 61b is fitted to the inner side of the bush 65. The bush 65 supports the output shaft 61 so that the output shaft 61 is capable of rotating around the output central axis J3. The flange portion 61b is supported from below by the end portion of the output-shaft holder 33b at the upper side via the flange portion of the bush 65. The opening portion 61d of the output shaft 61 at the lower side is disposed at the lower side from the bush 65.

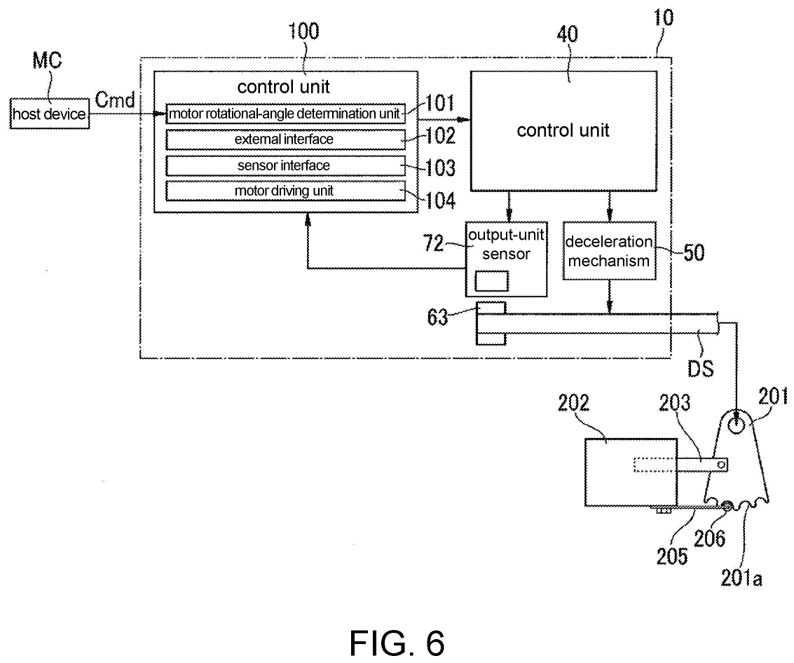

FIG. 6 is a functional block diagram of the electric actuator of the embodiment. The electric actuator 10 of the embodiment includes a control unit 100 that controls operations of the electric actuator 10. The control unit 100 is electrically connected to the motor unit 40 and the output-unit sensor 72. The control unit 100 is installed on the circuit board 70. The control unit 100 is electrically connected to a host device MC via an external-connection connector (not illustrated) of the electric actuator 10. Besides, the control unit 100 may be installed on a board which is positioned at the outer side of the housing 11.

The control unit 100 drives the motor unit 40 based on an output-shaft rotating command Cmd from the host device MC connected to the electric actuator 10. In a case of the embodiment, the control unit 100 includes a motor rotational-angle determination unit 101 that interprets the output-shaft rotating command Cmd to determine a rotational angle of the motor unit 40, an external interface 102 that executes communication with the host device MC, a sensor interface 103 that executes communication with the output-unit sensor 72, and a motor driving unit 104 that drives the motor unit 40. The control unit 100 may be configured as an integrated circuit or may be configured by a combination of a plurality of electronic circuits. The control unit 100 may have a configuration in which some or all functions thereof are implemented by software.

The motor rotational-angle determination unit 101 determines an angle θm by which the motor shaft 41 is rotated based on the output-shaft rotating command Cmd, the angle being necessary for rotating the output shaft 61 from a rotation starting position to a rotation ending position.

The external interface 102 executes transmission and reception of various items of information between the control unit 100 and the host device MC.

The sensor interface 103 acquires angular-position information from the output-unit sensor 72. The motor driving unit 104 rotates the motor shaft 41 by the angle θm determined by the motor rotational-angle determination unit 101.

Next, operations in a case of using the electric actuator 10 of the embodiment in a range switching actuator device of an automatic transmission are described.

In this case, the host device MC is an electronic control unit (ECU) of a vehicle, and the driven shaft DS is a manual shaft connected to a manual valve of the automatic transmission. Besides, this case is not limited to a configuration in which the driven shaft DS itself is a manual shaft, and a configuration may be employed in which the driven shaft DS is coupled to the manual shaft of the automatic transmission via a gear, a ball screw, or the like.

As illustrated in FIG. 6, a detent lever 201 that is rotated together with the driven shaft DS is coupled to the driven shaft DS which functions as the manual shaft of the automatic transmission. A manual valve 203 of a hydraulic control device 202 is coupled to the detent lever 201. The manual valve 203 relatively advances or retreats with respect to the hydraulic control device 202 along with a rotating operation of the detent lever 201.

The detent lever 201 has, at a front end portion, a positioning portion 201a in which recessed portions and projecting portions are continuously formed. A roller 206 that is positioned at a front end of a detent spring 205 having one end fixed to the hydraulic control device 202 is inserted into the recessed portion of the positioning portion 201a. The roller 206 is pushed into the recessed portion of the positioning portion 201a by a spring force of the detent spring 205. The detent lever 201 is held by the detent spring 205 at an angle corresponding to a shift range.

When a range is switched through a shift lever operation by a driver, the host device MC outputs, to the electric actuator 10, the output-shaft rotating command Cmd for changing an angular position of the manual shaft (driven shaft DS).

The control unit 100 receives the output-shaft rotating command Cmd via the external interface 102. The control unit 100 acquires a current angular position P0 of the driven shaft DS from the output-unit sensor 72 via the sensor interface 103.

The control unit 100 calculates an angle, by which the output shaft 61 is rotated, based on the output-shaft rotating command Cmd in the motor rotational-angle determination unit 101.

Specifically, the control unit acquires a current shift range SRO based on the angular position P0 of the driven shaft DS which is acquired from the output-unit sensor 72. In addition, the motor rotational-angle determination unit 101 acquires a shift range SR1 of a movement destination which is contained in the output-shaft rotating command Cmd.

The motor rotational-angle determination unit 101 has a table for converting a plurality of shift ranges into respective angular positions of the driven shaft DS. With reference to the table, the motor rotational-angle determination unit 101 converts the current shift range SR0 and the shift range SR1 of the movement destination into angular positions of the driven shaft DS and calculates, from the obtained angular positions, an angle θs by which the output shaft 61 and the driven shaft DS are rotated.

The motor rotational-angle determination unit 101 sets the angular position P0 of the driven shaft DS detected by the output-unit sensor 72 as a rotation starting position SP of the output shaft 61. The motor rotational-angle determination unit 101 determines, as the angle θm by which the motor shaft 41 of the motor unit 40 is rotated, a value obtained by multiplying the angle θs by which the output shaft 61 is rotated and a deceleration ratio (for example, 60) of the deceleration mechanism 50.

The control unit 100 drives the motor unit 40 by the motor driving unit 104 and rotates the motor shaft 41 by the angle θm. Consequently, the output shaft 61 and the driven shaft DS are rotated by the angle θs via the deceleration mechanism 50. The detent lever 201 coupled to the driven shaft DS is rotated by a predetermined angle, and the manual valve 203 is moved, thereby switching the shift range of the automatic transmission.

Besides, an angle larger than the angle obtained by multiplying the angle θs by which the output shaft 61 is rotated and the deceleration ratio of the deceleration mechanism 50 may be set as the angle θm by which the motor shaft 41 is rotated. By determining the angle θm with consideration for a dead zone at the start of driving of the electric actuator 10 in advance, positional accuracy of a rotation ending position of the driven shaft DS can be improved.

An extent to which the angle, as the angle θm by which the motor shaft 41 is rotated, is larger than the angle θs by which the output shaft 61 is rotated may be set corresponding to a degree of play of the driven shaft DS in a state of being coupled to the electric actuator 10. The degree of play of the driven shaft DS in the state of being coupled to the electric actuator 10 can be defined as an angular tolerance ±0a of a total of position control accuracy of the output shaft 61 by the motor unit 40, a backlash at a coupled portion between the output shaft 61 and the driven shaft DS, and a backlash of the deceleration mechanism 50.

In the case described above, the angle θm by which the motor shaft 41 is rotated can be set as an angle obtained by multiplying an angle (θs+θa/2) by the deceleration ratio of the deceleration mechanism 50, the angle (θs+θa/2) being obtained by adding the angle θs by which the output shaft is rotated and an angle (θa/2) which is one half of an upper limit value θa of the angular tolerance ±θa. According to this configuration, one half of an upper limit value of the play of the driven shaft DS caused by machine accuracy of the electric actuator 10 is set as the dead zone at the start of driving, and the driven shaft DS is further rotated correspondingly. Consequently, in the detent lever 201 illustrated in FIG. 6, a range of a lack of rotation due to play is reduced, and a range of angular deviation at rotation ending position of the driven shaft DS can be reduced.

After rotating the motor driving unit 104 by the driven shaft DS, the control unit 100 acquires an output signal of the output-unit sensor 72 via the sensor interface 103. The control unit 100 acquires an angular position P1 of the driven shaft DS based on the output signal from the output-unit sensor 72. The control unit 100 compares the acquired angular position P1 and an angular position (P0+θs) at which the driven shaft DS is to be disposed by a range switching operation. As a result of the comparison, when the angular position P1 is not coincident with the angular position (P0+θs), the control unit 100 outputs error information to the host device MC via the external interface 102.

As described above, the electric actuator 10 of the embodiment rotates the driven shaft DS by open-loop control and executes range switching of the automatic transmission. In the electric actuator 10 of the embodiment, a backlash is reduced by optimizing a tooth shape of the external gear 51 and the internal gear 52 in the deceleration mechanism 50, and the position detecting accuracy is improved by directly detecting the angular position of the driven shaft DS by the output-unit sensor 72. According to these configurations, the position of the driven shaft DS can be controlled with high accuracy. As a result, feedback of the angular position of the driven shaft DS is unnecessary, and the range switching by the open-loop control can be achieved.

More specifically, in the electric actuator 10 of the embodiment, the position accuracy is one tenth or smaller of a maximum conversion angle. In the embodiment, the maximum conversion angle is the maximum range of an angle by which the electric actuator 10 rotates the driven shaft DS, and is about 20°, for example.

In the electric actuator 10 of the embodiment, a total of the position control accuracy of the output shaft 61 by the motor unit 40, the backlash at the coupled portion between the output shaft 61 and the driven shaft DS, the backlash of the deceleration mechanism 50, and the position detecting accuracy of the output-unit sensor 72 is one tenth or smaller of the maximum conversion angle. According to this configuration, when the driven shaft DS is the manual shaft of the automatic transmission, an angular position of the detent lever 201 can be controlled at an accuracy of one tenth or smaller of the maximum conversion angle, and accurate range switching can be performed in an automatic transmission for a general vehicle.

According to the electric actuator 10 of the embodiment, compared with closed-loop control in which the driven shaft DS is rotated while feedback of a detection value from the output-unit sensor 72 is performed, the motor unit 40 can be operated at a high speed and the driven shaft DS can be rotated at a high speed. Hence, by using the electric actuator 10 of the embodiment in the automatic transmission, a speed of the range switching is improved.

In addition, according to the electric actuator 10 of the embodiment, the range switching speed of the automatic transmission can be improved, and thus, for example, a period of time taken to enable a vehicle to start when ignition of the vehicle is turned on can be shortened. In addition, according to the electric actuator 10 of the embodiment, the angular position of the driven shaft DS is used only for the detection performed to set the rotation starting position SP, and feedback of the angular position is not performed during the rotation of the driven shaft DS. Therefore, the position control accuracy of the driven shaft DS is unlikely to be influenced by a change in detection accuracy of the output-unit sensor 72 due to external disturbance. Hence, according to the electric actuator 10 of the embodiment, robust characteristics of angular control of the driven shaft DS is improved.

In addition, according to the electric actuator 10 of the embodiment, the angular position of the output shaft 61 and the driven shaft DS can be directly detected by the output-unit sensor 72, and thus initial position detection of the output shaft 61 is not required. In the electric actuator 10, when the initial position detection of the output shaft 61 is performed without using the output-unit sensor 72, operations such as rotating the driven shaft DS to a rotation limit position to detect the initial position or rotating the sector drive gear 62 in one direction bring the sector drive gear 62 into contact with the housing body 11a are executed. Range switching cannot be performed during execution of the initial position detection, and thus a start time lag occurs when the ignition is turned on, for example. In addition, during the initial position detecting operation, abnormal sound occurs when the driven shaft DS comes up against a rotation stop or the drive gear 62 comes into contact with the housing body 11a. According to the electric actuator 10 of the embodiment, good drivability and quietness are obtained without a side effect of the initial position detection described above.

The disclosure is not limited to the embodiment described above and can employ other configurations.

The embodiment employs a configuration in which the angular position of the driven shaft DS is detected by the output-unit sensor 72 installed in the electric actuator 10; however, the angular position of the driven shaft DS may be detected by a sensor arranged outside the electric actuator 10. For example, the angular position of the driven shaft DS can be detected in the automatic transmission including the driven shaft DS. In this case, the host device MC transmits, to the electric actuator 10, the output-shaft rotating command Cmd including the angular position of the driven shaft DS which is detected in the automatic transmission.

The embodiment employs a configuration in which the angle by which the output shaft 61 and the driven shaft DS are rotated is calculated in the motor rotational-angle determination unit 101; however, the following configuration may be employed in which the output-shaft rotating command Cmd supplied from the host device MC includes the angle by which the output shaft 61 and the driven shaft DS are rotated. According to this configuration, a decrease in computation in the motor rotational-angle determination unit 101 is achieved, and thus the electric actuator 10 can be operated at a higher speed. In addition, in the configuration in which the angular position of the driven shaft DS is detected in the automatic transmission, the current angular position of the driven shaft DS is not detected in the electric actuator, and thus in an embodiment it is to supply, from the host device MC to the electric actuator, the output-shaft rotating command Cmd including the angle by which the output shaft 61 and the driven shaft DS are rotated.

The application of the electric actuator of the embodiment described above is not particularly limited and may be mounted on an apparatus other than a vehicle. In addition, the configurations described above can be appropriately combined within a range in which the configurations are compatible with each other.

What is claimed is:

1. An electric actuator comprising:
a motor unit having a motor shaft extending in an axial direction;
a deceleration mechanism that is coupled to one side or the other side of the motor shaft in the axial direction;
an output unit having an output shaft to which rotation of the motor shaft is transmitted via the deceleration mechanism; and
a control unit that drives the motor unit based on an output-shaft rotating command which is input from a host device,
wherein the control unit comprises
a motor rotational-angle determination unit that determines a rotational angle of the motor shaft based on the output-shaft rotating command, the rotational angle being necessary for rotating the output shaft from a rotation starting position to a rotation ending position, and
a motor driving unit that rotates the motor shaft by the rotational angle determined by the motor rotational-angle determination unit.

2. The electric actuator according to claim 1,
wherein an angle by which the motor shaft is rotated and which is determined in the motor rotational-angle determination unit is larger than an angle obtained by multiplying an angle by which the output shaft is rotated by a deceleration ratio of the deceleration mechanism.

3. The electric actuator according to claim 2,
wherein the angle by which the motor shaft is rotated and which is determined in the motor rotational-angle determination unit is an angle obtained by multiplying an angle (θs+θa/2) by a deceleration ratio of the deceleration mechanism, the angle (θs+θa/2) being obtained by adding
an angle θs by which the output shaft is rotated, and
an angle θa/2 being one half of an upper limit value θa of angular tolerance of a total of position control accuracy of the output shaft by the motor unit, a backlash at a coupled portion between the output shaft and a driven shaft coupled to the output shaft, and a backlash of the deceleration mechanism.

4. The electric actuator according to claim 1, further comprising
an output-unit sensor that detects an angular position of the driven shaft which is coupled to the output shaft.

5. The electric actuator according to claim 4,
wherein the output shaft and the motor shaft are disposed to be separated from each other in a radial direction of the motor shaft, and
wherein the output-unit sensor detects an angular position of the driven shaft which is coupled to the output shaft.

6. The electric actuator according to claim 5,
wherein the output-unit sensor detects a magnetic field of a sensor magnet which is mounted on the driven shaft.

7. The electric actuator according to claim 4,
wherein the motor rotational-angle determination unit uses the angular position of the driven shaft detected by the output-unit sensor as the rotation starting position of the output shaft.

8. The electric actuator according to claim 1,
wherein the deceleration mechanism comprises
an external gear that is connected to the motor shaft and centred on an axis eccentric with respect to a central axis of the motor shaft,
an internal gear that is fixed to surround an outer side of the external gear in a radial direction thereof and intermeshes with the external gear, and
an output gear having a plurality of pins passing through a plurality of holes arranged in the external gear, respectively;
wherein the external gear has a first gear portion having a shape in which flat portions that configure addenda and first arcs that configure dedenda are alternately continuous, when viewed in the axial direction,
wherein the internal gear has a second gear portion having a shape in which second arcs that configure dedenda and third arcs that configure addenda are alternately continuous, when viewed in the axial direction, and
wherein the flat portion of the first gear portion is positioned at an inner side in the radial direction from a virtual circle obtained by connecting centres of a plurality of the first arcs.

9. The electric actuator according to claim 1,
wherein the driven shaft coupled to the output shaft is a manual shaft of an automatic transmission, and
wherein position control accuracy of the manual shaft is one tenth or smaller of a maximum conversion angle.

10. The electric actuator according to claim 4,
wherein the driven shaft which is coupled to the output shaft is a manual shaft of an automatic transmission, and
wherein a total value of the position control accuracy of the output shaft by the motor unit, the backlash at the coupled portion between the output shaft and the driven shaft coupled to the output shaft, the backlash of the deceleration mechanism, and position detecting accuracy of the output-unit sensor is one tenth or smaller of a maximum conversion angle.
